(19) United States
(12) Patent Application Publication
(10) Pub. No.: US 2007/0231684 A1
(43) Pub. Date: Oct. 4, 2007

(54) Lithium secondary battery

(76) Inventors: Yasuo Takano, Osaka (JP); Keiji Saisho, Osaka (JP); Hidekazu Yamamoto, Osaka (JP)

Correspondence Address: KUBOVCIK & KUBOVCIK, SUITE 710, 900 17TH STREET NW, WASHINGTON, DC, 20006, US

(21) Appl. No.: 11/729,904

(22) Filed: Mar. 30, 2007

(30) Foreign Application Priority Data
Mar. 31, 2006 (JP) 2006-098759

(51) Int. Cl. H01M 2/26; H01M 4/58; H01M 4/62; H01M 2/02

(52) U.S. Cl. 429/161; 429/128; 429/218.1; 429/217; 429/176

(57) ABSTRACT

A lithium secondary battery includes: a plurality of sheets of a positive electrode; at least one sheet of a negative electrode; a separator disposed between each of the positive electrode sheets and the negative electrode sheet; an electrode assembly (20) including the positive electrode, the negative electrode, and the separators; a battery case for accommodating the electrode assembly; and positive electrode current collector tabs (1), attached to individual sheets of the positive electrode, for connecting the sheets of the positive electrode to a positive electrode terminal portion of the battery case. The electrode assembly (20) is formed so that the plurality of sheets of positive electrode and the at least one sheet of the negative electrode are stacked with the separators interposed therebetween. In the electrode assembly in which the electrodes are stacked, the positive electrode current collector tabs are disposed staggered at a plurality of locations.

### BACKGROUND OF THE INVENTION

1. Field of the Invention

The present invention relates to lithium secondary batteries.

2. Description of Related Art

Lithium secondary batteries have been widely used as the power source for portable electronic devices related to information technology, such as mobile telephones and notebook computers, owing to their high energy density. It has been expected that, due to further size reduction and advanced functions of these portable devices, requirements for lithium secondary batteries as the device power sources will continue to escalate in the future, and thus, demands for higher energy density in lithium secondary batteries have been increasingly high.

An effective means for increasing the energy density of a battery is to use a material that has a larger energy density as the active material. Recently, there have been various proposals and investigations into the use, in lithium secondary batteries, of alloy materials of elements that are capable of intercalating lithium through an alloying reaction with lithium, such as aluminum, tin, and silicon, as a negative electrode active material that achieves a higher energy density, in place of graphite.

In an electrode that uses a material capable of alloying with lithium as the active material, however, the active material expands and shrinks in volume during the intercalation and deintercalation of lithium, causing the active material to pulverize or peel off from the current collector. This leads to various problems such as degradation in the current collection performance within the electrode and deterioration in charge-discharge cycle performance.

A problem with a lithium secondary battery that uses this type of negative electrode is as follows. In an electrode assembly in which the positive electrode and the negative electrode oppose each other across a separator, the negative electrode active material layer may be bent at a location where the positive electrode active material layer and the negative electrode active material layer face each other. In this bent portion, the stress caused by a large volumetric change of the negative electrode active material during the lithium intercalation and deintercalation cannot be alleviated. This causes destruction of the electrode structure and consequently degrades the current collection performance, resulting in poor charge-discharge characteristics.

As techniques to resolve the above-described issues, Japanese Published Unexamined Patent Application No. 2005-174653 proposes an electrode assembly structure in which a negative electrode is folded and overlapped alternately and a plurality of sheets of positive electrode is disposed between overlapping surfaces of the negative electrode to form layers of the positive electrode and the negative electrode, and an electrode assembly structure in which a plurality of sheets of positive electrode and a plurality of sheets of negative electrode are alternately stacked. However, a problem with these types of electrode assemblies is that, since these types of electrode assemblies use a plurality of electrode sheets and accordingly require a plurality of current collector tabs (as shown in FIG. 7) for connecting the electrode sheets to a terminal portion of the battery case, a space for accommodating these collector tabs is necessary, causing the volumetric energy density of the battery to be reduced.

Japanese Published Unexamined Patent Application No. 9-171809 discloses a technique in which a current collector tab of the electrode assembly is fixed to a sealing plate that is part of the battery case by laser welding. If the number of electrode sheets increases as described above, the number of current collector tabs correspondingly increases. Thus, a problem arises that such a large number of overlapped current collector tabs cannot be fixed to the sealing plate by laser welding.

### BRIEF SUMMARY OF THE INVENTION

It is an object of the present invention to provide a lithium secondary battery employing a plurality of sheets of a positive electrode that requires less space in the battery case and achieves a higher battery energy density.

The present invention provides a lithium secondary battery comprising: a plurality of sheets of a positive electrode; at least one sheet of a negative electrode; a separator disposed between the sheets of the positive electrode and the at least one sheet of the negative electrode; an electrode assembly comprising the plurality of sheets of the positive electrode, the at least one sheet of the negative electrode, and the separator, in which the plurality of sheets of the positive electrode and the at least one sheet of the negative electrode are stacked with the separator interposed therebetween; a battery case for accommodating the electrode assembly; and positive electrode current collector tabs, each attached to an individual sheet of the positive electrode, for connecting the sheets of the positive electrode to a positive electrode terminal portion of the battery case, the positive electrode current collector tabs being disposed staggered at a plurality of locations in the electrode assembly in which the electrodes are stacked.

The present invention makes available a lithium secondary battery employing a plurality of sheets of a positive electrode that requires less space in the battery case and achieves a higher battery energy density.

### BRIEF DESCRIPTION OF THE DRAWINGS

FIG. 1 is a partially cut-away perspective view illustrating one example of the lithium secondary battery according to the present invention;

FIG. 2 is a partially cut-away perspective view illustrating a conventional lithium secondary battery;

FIG. 3 is a plan view illustrating an electrode assembly used in the example of the lithium secondary battery of the present invention;

FIG. 4 is a cross-sectional view taken along line IV-IV in FIG. 3;

FIG. 5 is a cross-sectional view illustrating the structure of the electrode assembly in another example of the lithium secondary battery according to the present invention;

FIG. 6(A) is a perspective view illustrating an electrode assembly of the present invention and showing the positive electrode current collector tabs staggered at five locations;

FIG. 6(B) is a perspective view illustrating the electrode assembly of FIG. 6(A) inserted in a battery can; and

FIG. 7 is a perspective view of the electrode assembly of Japanese Published Unexamined Patent Application No. 2005-174653.

### DETAILED DESCRIPTION OF THE INVENTION

A lithium secondary battery in accordance with the present invention comprises: a plurality of sheets of a positive electrode; at least one sheet of a negative electrode; a separator disposed between the sheets of the positive electrode and the at least one sheet of the negative electrode; an electrode assembly comprising the plurality of sheets of the positive electrode, the at least one sheet of the negative electrode, and the separators; a battery case for accommodating the electrode assembly; and positive electrode current collector tabs. In the electrode assembly, the plurality of sheets of the positive electrode and the at least one sheet of the negative electrode are stacked with the separators interposed therebetween. The positive electrode current collector tabs are attached to the sheets of the positive electrode, for connecting the sheets of the positive electrode to a positive electrode terminal portion of the battery case. The positive electrode current collector tabs are disposed staggered at a plurality of locations in the electrode assembly in which the electrodes are stacked.

In a conventional electrode assembly that uses a plurality of sheets of a positive electrode, the positive electrode current collector tabs are provided at the same location. Thus, a large number of positive electrode current collector tabs need to be bundled into one when enclosing these positive electrode current collector tabs into a battery case, but the conventional electrode assembly requires a space for accommodating the bundled positive electrode current collector tabs. This results in the problem of a lower volumetric energy density of the battery.

Another problem has been that laser welding cannot be used to attach such a large number of overlapping positive electrode current collector tabs to the positive electrode terminal portion of the battery case.

In the present invention, the positive electrode current collector tabs are disposed staggered at a plurality of locations. Therefore, the number of positive electrode current collector tabs that are overlapped at the same location is small, making it possible to reduce the space for accommodating the positive electrode current collector tabs and to prevent the volumetric energy density of the battery from being lowered.

In addition, the present invention makes it possible to lessen the number of positive electrode current collector tabs overlapped at the same location since the positive electrode current collector tabs are disposed staggered at a plurality of locations. Therefore, the positive electrode current collector tabs can be easily connected to the positive electrode terminal portion of the battery case by laser welding.

Moreover, since the positive electrode current collector tabs are connected to the positive electrode terminal portion at a plurality of locations, the current collection resistance can be reduced.

It is preferable that in the electrode assembly in which the electrodes are stacked, the number of the positive electrode current collector tabs that are overlapped at a same location is three or less. By restricting the number of the positive electrode current collector tabs to three or less, the space for accommodating the current collector tabs can be reduced, and at the same time, the current collector tabs can be easily connected to the positive electrode terminal portion by laser welding.

In the present invention, the thickness of the positive electrode current collector tabs is not particularly limited, but it is preferable that the thickness of each of the positive electrode current collector tabs be 50 μm or less, and more preferably within the range of from 10 μm to 30 μm.

In the electrode assembly according to the present invention in which the electrodes are stacked, it is preferable that the at least one sheet of the negative electrode is folded and overlapped alternately and that the sheets of the positive electrode are disposed between overlapping surfaces of the negative electrode, whereby the sheets of the positive electrode and the at least one sheet of the negative electrode are stacked. Such an electrode assembly may be made of a plurality of sheets of the positive electrode and a single sheet of the negative electrode.

In the present invention, it is also possible to adopt a stacked structure in which a plurality of sheets of the positive electrode and a plurality of sheets of the negative electrode are alternately stacked.

In the electrode assembly according to the present invention in which the electrodes are stacked, it is preferable that the positive electrode not be present on an outer side of a bent portion of the negative electrode. Since the positive electrode is not present on the outer side of the bent portion of the negative electrode, the stress that is caused by the change in volume of the active material, associated with the intercalation and deintercalation of lithium, can appropriately escape in the outward direction, that is, toward the outer side. This prevents the destruction of the active material layer and the peeling of the active material layer from the current collector, improving the charge-discharge cycle performance.

In the present invention, it is preferable that the negative electrode contain silicon as an active material. For example, it is possible to use particles of silicon and/or a silicon alloy as the negative electrode active material. It is also possible to adopt a negative electrode in which a silicon thin film is formed on a negative electrode current collector by such techniques as CVD, sputtering, and thermal spraying.

In the present invention, it is preferable that the negative electrode comprise a negative electrode current collector and a negative electrode mixture layer sintered on the negative electrode current collector, the negative electrode mixture layer containing a negative electrode binder and an active material containing silicon. It is preferable that the sintering be carried out under a non-oxidizing atmosphere. The sintering under a non-oxidizing atmosphere may be carried out, for example, under vacuum, or under a nitrogen atmosphere, or under an inert gas atmosphere such as an argon atmosphere. It is also possible to carry out the sintering under a reducing atmosphere such as a hydrogen atmosphere. The heat processing temperature for the sintering should preferably be lower than the melting points of the metal foil current collector and the active material particles. For example, in the case of using a copper foil as the metal foil current collector, it is preferable that the sintering be carried out at a temperature lower than 1083° C., which is the melting point of copper, more preferably within a temperature range of from 200° C. to 500° C., and still more preferably within a temperature range of from 300° C. to 450° C. The sintering may be carried out by a discharge plasma sintering technique or hot pressing.

The following describes a negative electrode, a positive electrode, and a non-aqueous electrolyte of the lithium secondary battery according to the present invention.

Negative Electrode

Examples of the negative electrode active materials usable in the present invention include particles of silicon and/or a silicon alloy. Examples of silicon alloys include a solid solution of silicon and at least one other element, an intermetallic compound of silicon and at least one other element, and an eutectic alloy of silicon and at least one other element. Examples of the method for producing the alloys include arc melting, liquid quenching, mechanical alloying, sputtering, chemical vapor deposition, and baking. Specific examples of the liquid quenching include a single-roll quenching technique, a double-roller quenching technique, and various atomization techniques such as gas atomization, water atomization, and disk atomization.

The negative electrode active material particles used in the present invention may be ones in which surfaces of the particles of silicon and/or a silicon alloy are coated with a metal or the like. Examples of a method of coating include electroless plating, electroplating, a chemical reduction technique, evaporation, sputtering, and chemical vapor deposition. It is preferable that the metal that is coated on the surfaces of the particles be the same kind of metal as that used for the current collector. Coating the surfaces of the particles with the same kind of metal as used for the current collector improves the binding between the particles and the current collector in the sintering, making it possible to obtain even better charge-discharge cycle performance.

The negative electrode active material particles used in the present invention may contain particles made of a material that is capable of alloying with lithium. Examples of the materials capable of alloying with lithium include germanium, tin, lead, zinc, magnesium, sodium, aluminum, gallium, indium, and alloys thereof.

Although not particularly limited, the average particle size of the negative electrode active material in the present invention is preferably 100 μm or less, more preferably 50 μm or less, and most preferably 10 μm or less. The smaller the particle size of the active material particles is, the better the cycle performance tends to be. The average particle size of the conductive powder, which is added to the mixture layer, is also preferably, but not necessarily limited to, 100 μm or less, more preferably 50 μm or less, and most preferably 10 μm or less.

Using active material particles with a small particle size serves to reduce the absolute amount of the expansion and shrinkage in volume of the active material particles, which accompany the intercalation and deintercalation of lithium in the charge-discharge reactions. This accordingly reduces the absolute amount of the strain between the active material particles in the electrode during the charge-discharge reactions, preventing the binder from being disintegrated and the current collection performance in the electrode from degrading. Thus, good charge-discharge cycle performance can be obtained.

It is preferable that the particle size distribution of the active material particles be as narrow as possible. A wide particle size distribution will cause large differences in the absolute amounts of volumetric expansion and shrinkage, which accompany the intercalation and deintercalation of lithium, between the active material particles which have varying particle sizes. Therefore, a strain will occur in the mixture layer, and consequently, destruction of the negative electrode binder will occur, degrading the current collection performance in the electrode and thereby lowering the charge-discharge performance.

In the present invention, it is preferable that the negative electrode current collector have an arithmetical mean surface roughness Ra of 0.2 μm or greater. The use of a current collector having such an arithmetical mean surface roughness serves to increase the contact area between the mixture layer and the current collector, also improving the adhesion between the mixture layer and the current collector. Therefore, the current collection performance in the electrode can be further improved. In the case that the mixture layer is disposed on both sides of the current collector, it is preferable that both surfaces of the current collector have an arithmetical mean surface roughness Ra of 0.2 μm or greater.

Arithmetical mean surface roughness Ra is defined in Japanese Industrial Standard (JIS) B 0601-1994. Arithmetical mean surface roughness Ra can be measured by, for example, a surface roughness meter.

It is preferable that the just-mentioned arithmetical mean surface roughness Ra and mean spacing of local peaks S have a relationship 100Ra≧S. Mean spacing of local peaks S is also defined in Japanese Industrial Standard (JIS) B 0601-1994, and can be measured by, for example, a surface roughness meter.

In the present invention, although not particularly limited, it is preferable that the thickness of the negative electrode current collector be within the range of from 10 μm to 100 μm.

In the present invention, the upper limit of the arithmetical mean surface roughness Ra of the negative electrode current collector is not particularly limited. That said, because it is preferable that the thickness of the current collector be within the range of from 10 μm to 100 μm, it is accordingly preferable that the upper limit of the arithmetical mean surface roughness Ra of the current collector surface be 10 μm or less.

In the present invention, the negative electrode current collector is formed of a conductive metal foil. Illustrative examples of the conductive metal foil include those made of a metal such as copper, nickel, iron, titanium, and cobalt, and those made of alloys thereof. It is especially preferable to use a conductive metal foil that contains a metal element that easily diffuses into the negative electrode active material. Examples of such a metal foil include a metal foil containing elemental copper, especially a copper foil and a copper alloy foil. Since copper easily diffuses into the silicon material, which is an active material, through a heat treatment, it is expected that the adhesion between the current collector and the active material will be improved by the sintering. When it is intended that the adhesion between the current collector and the active material be improved by sintering, it is desirable to use, as the current collector, a metal foil in which a layer containing elemental copper is present in the current collector surface that comes in contact with the active material. Therefore, when using a metal foil made of a metal element other than copper, it is preferable to form a copper layer or a copper alloy layer on its surface.

It is preferable that a heat-resistant copper alloy foil be used as the copper alloy foil. The heat-resistant copper alloy refers to a copper alloy that has a tensile strength of 300 MPa or greater after having been annealed at 200° C. for 1 hour.

In the present invention, it is preferable that the negative electrode current collector have a large surface roughness, as discussed above. When the surface of the heat-resistant copper alloy foil does not have a sufficiently large arithmetical mean surface roughness Ra, it is possible to provide a large surface roughness by providing an electrolytic copper layer or an electrolytic copper alloy layer on the foil surface.

In the present invention, in order to provide the surface of the negative electrode current collector with a large surface roughness, the current collector may be subjected to a roughening process. Examples of the roughening process include vapor deposition, etching, and polishing. Examples of the vapor deposition include sputtering, chemical vapor deposition, and evaporation. Examples of the etching include techniques by physical etching and chemical etching. Examples of the polishing include polishing by sandpaper and polishing by blasting.

In the present invention, it is preferable that the negative electrode mixture layer thickness X have relationships with the negative electrode current collector thickness Y and the surface roughness such that 5Y≧X and 250Ra≧X. If the thickness X of the mixture layer exceeds 5Y or 250Ra, the mixture layer may peel off from the current collector.

Although not particularly limited, it is preferable that the thickness X of the negative electrode mixture layer be 1000 μm or less, and more preferably from 10 μm to 100 μm.

In the present invention, the negative electrode mixture layer may also contain conductive powder. By adding conductive powder to the mixture layer, a conductive network originating from the conductive powder forms around the active material particles, further improving the current collection performance within the electrode. The conductive powder is preferably made of the same material as the material of the current collector. Specific examples include metals such as copper, nickel, iron, titanium, and cobalt, as well as alloys and mixtures thereof. In particular, copper powder is preferable among the metal powders. Conductive carbon powder is also a preferred material.

It is preferable that the amount of the conductive powder to be added to the negative electrode mixture layer be 50 mass % or less of the total weight of the conductive powder and the active material particles. If the amount of the conductive powder added is too large, the charge-discharge capacity of the electrode will be too small because the ratio of the active material particles becomes relatively less.

In the present invention, it is preferable to use a negative electrode binder that remains without being completely decomposed even after the heating process for the sintering. When the binder remains undecomposed even after the heat processing, the adhesion between the current collector and the active material particles and the adhesion of the active material particles to one another are further improved because the binding capability of the binder aids an improvement effect to the adhesion resulting from the sintering. Moreover, when a conductive metal foil having an arithmetical mean surface roughness Ra of 0.2 μm is used as the current collector, the binder gets into the portions of the current collector surface in which the surface irregularities exist, exerting an anchoring effect between the binder and the current collector and further improving the adhesion. As a result, it becomes possible to prevent the peeling of the active material layer from the current collector resulting from the expansion and shrinkage in volume of the active material that accompany the intercalation and deintercalation of lithium, and to obtain good charge-discharge cycle performance.

In the present invention, it is preferable that the negative electrode binder be composed of a polyimide. Examples of the polyimide include thermoplastic polyimides and thermosetting polyimides. Thermosetting polyimides are particularly preferable. When a thermoplastic polyimide that has a low glass transition temperature is used as the negative electrode binder, the current collection performance in the electrode can be significantly enhanced because the negative electrode can be sintered at a temperature higher than the glass transition temperature so that the binder can thermally bond to the active material particles and the current collector, improving the adhesion. In other words, when the heat processing temperature for sintering the negative electrode mixture layer and the conductive metal foil negative electrode current collector is higher than the glass transition temperature of the negative electrode binder, the current collection performance within the electrode significantly improves because the effect of improving the adhesion by the thermal bonding of the binder is obtained in addition to the effect of improving the adhesion by the sintering.

It should be noted that the polyimide may be obtained by heat-treating a polyamic acid. The polyimide obtained by heat-treating a polyamic acid is such that the polyamic acid undergoes dehydration condensation by the heat treatment to form a polyimide. It is preferable that the imidization ratio of the polyimide be 80% or higher. The imidization ratio is a mole percent of the polyimide produced with respect to the polyimide precursor (polyamic acid). A polyimide with an imidization ratio of 80% or higher may be obtained by, for example, heat-treating an N-methyl-2-pyrrolidone (NMP) solution of a polyamic acid for 1 hour or longer at 100° C. to 400° C. For example, in the case of heat-treating the material at 350° C., the imidization ratio reaches 80% by heat treatment for about 1 hour, and the imidization ratio reaches 100% in about 3 hours.

In the present invention, it is preferable that when a polyimide is used as the binder, the sintering process be carried out at 600° C. or lower, at which the polyimide is not completely decomposed, because it is preferable that the binder remain undecomposed even after the heat processing for sintering.

In the present invention, it is preferable that the amount of the binder in the negative electrode mixture layer be 5 weight % or greater of the total weight of the mixture layer. It is also preferable that the volume of the binder be 5% or greater of the total volume of the mixture layer. If the amount of the binder in the mixture layer is too small, the adhesion within the electrode that is provided by the binder may be insufficient. On the other hand, if the amount of the binder in the mixture layer is too large, the resistance within the electrode becomes high, resulting in difficulties in the initial charge. For these reasons, it is preferable that the amount of the binder in the mixture layer be 50 weight % or less of the total weight of the mixture layer, and that the volume of the binder be 50% or less of the total volume of the mixture layer.

Positive Electrode

Examples of the positive electrode active material that may be used in the present invention include lithium-containing transition metal oxides, such as LiCoO₂, LiNiO₂, LiMn₂O₄, LiMnO₂, LiCo_{0.5}Ni_{0.5}O₂, and LiNi_{0.7}Co_{0.2}Mn_{0.1}O₂, and metal oxides that do not contain lithium, such as MnO₂. In addition, various substances may be used without limitation as long as such substances are capable of electrochemically intercalating and deintercalating lithium. The positive electrode binder used in the present invention may be any binder that can be used as an electrode binder for lithium secondary batteries. Examples include fluoropolymers, such as polyvinylidene fluoride, and polyimide resins, which is preferably used as the negative electrode binder.

Non-Aqueous Electrolyte

Examples of the solvents of the non-aqueous electrolyte usable for the lithium secondary battery of the present invention include, but are not particularly limited to, cyclic carbonates such as ethylene carbonate, propylene carbonate, butylene carbonate, and vinylene carbonate; and chain carbonates such as dimethyl carbonate, ethyl methyl carbonate, and diethyl carbonate. Cyclic carbonates are preferable because a good quality surface film with good lithium ion conductivity can be particularly easily formed on the surfaces of the active material particles if a cyclic carbonate is present in the solvent of the non-aqueous electrolyte. Ethylene carbonate is particularly preferable. Also preferred is a mixed solvent of a cyclic carbonate and a chain carbonate. In particular, it is preferable that such a mixed solvent contain ethylene carbonate and diethyl carbonate. Further examples include mixed solvents in which a cyclic carbonate is mixed with an ether-based solvent such as 1,2-dimethoxyethane and 1,2-diethoxyethane, or mixed with a chain ester such as y-butyrolactone, sulfolane, and methyl acetate.

Examples of the solute of the non-aqueous electrolyte include LiPF₆, LiBF₄, LiCF₃SO₃, LiN (CF₃SO₂)₂, LiN(C₂F₅SO₂)₂, LiN (CF₃SO₂)(C₄F₉SO₂), LiC (CF₃SO₂)₃, LiC (C₂F₅SO₂)₃, LiAsF₆, LiClO₄, Li₂B₁₀Cl₁₀, Li₂B₁₂Cl₁₂, and mixtures thereof. Preferable examples include LiXF_{y} (wherein X is P, As, Sb, B, Bi, Al, Ga, or In, and y is 6 when X is P, As, or Sb or y is 4 when X is B, Bi, Al, Ga, or In), lithium perfluoroalkylsulfonic imide LiN(CₘF₂₊₁SO₂)(CₙF₂ₙ₊₁SO₂) (wherein m and n denote, independently of one another, an integer of from 1 to 4), and lithium perfluoroalkylsulfonic methide LiC(CₚF₂ₚ₊₁SO₂)(C_{q}F_{2q+1}SO₂)(CᵣF₂ᵣ₊₁SO₂) (wherein p, q, and r denote, independently of one another, an integer of from 1 to 4).

Further examples of the electrolyte include a gelled polymer electrolyte in which an electrolyte solution is impregnated in a polymer electrolyte such as polyethylene oxide and polyacrylonitrile, and inorganic solid electrolytes such as LiI or Li₃N. There is no limitation to the electrolyte of the lithium secondary battery of the present invention, and it is possible to use any type of electrolyte as long as the lithium compound solute, which provides ionic conductivity, and the solvent, which dissolves and retains the solute, do not decompose at a voltage during the charge and discharge of the battery or at a voltage during the storage of the battery.

The separator used for the lithium secondary battery of the present invention is not particularly limited and can be any separator that is used as the separator for a lithium secondary battery. Examples include microporous films made of polyethylene or polypropylene.

Examples of the battery case used in the present invention include those made of aluminum, an aluminum alloy, or an aluminum laminate film.

Hereinbelow, the present invention is described in further detail based on examples thereof. It should be understood, however, that the present invention is not limited to the following examples but various changes and modifications are possible without departing from the scope of the invention.

Preparation of Positive Electrode

Lithium cobalt oxide, a carbon conductive agent (SP300), and acetylene black were mixed at a weight ratio of 92:3:2 to prepare a positive electrode mixture powder. Then, 200 g of the resultant mixture powder was charged into a mixer (e.g., mechanofusion system AM-15F made by Hosokawa Micron Corp.), which was operated at 1500 rpm for 10 minutes to mix the mixture powder under compression, impact, and shearing actions, whereby a positive electrode mixture was prepared.

Next, the resultant positive electrode mixture was mixed with a fluoropolymer-based binder agent (PVDF) in an N-methyl-2-pyrrolidone (NMP) solution so that the weight ratio of the positive electrode mixture to PVDF became 97:3, to thus prepare a positive electrode mixture slurry. The resultant positive electrode slurry was applied onto both sides of an aluminum foil, and the resultant material was thereafter dried and pressure-rolled. Thus, a positive electrode was prepared.

The weight of the coating of the positive electrode was 480 mg/10 cm² (excluding the weight of the current collector), and the thickness thereof was 143 μm.

Preparation of Negative Electrode

Silicon powder (purity: 99.9%) having an average particle size of 10 μm, which serves as a negative electrode active material, and a thermoplastic polyimide having a glass transition temperature of 190° C. and a density of 1.1 g/cm³, which serves as a negative electrode binder, were mixed together with N-methyl-2-pyrrolidone as a dispersion medium so that the weight ratio of the active material to the binder became 90:10, to thus prepare a negative electrode mixture slurry.

The resultant negative electrode mixture slurry was applied onto both sides of (roughened surfaces of) a negative electrode current collector made of an electrolytic copper foil (thickness 25 μm) having a surface roughness Ra of 1.0 μm, and then dried. The resultant material was pressure-rolled, and was thereafter sintered by a heat process under an argon atmosphere at 400° C. for 1 hour, to prepare a negative electrode.

The weight of the coating of the negative electrode was 56 mg/10 cm² (excluding the weight of the current collector), and the thickness thereof was 55 μm.

Preparation of Non-Aqueous Electrolyte Solution

LiPF₆ was dissolved at a concentration of 1 mole/liter into a mixed solvent of a 3:7 volume ratio of ethylene carbonate and diethyl carbonate, to prepare an electrolyte solution.

Preparation of Lithium Secondary Cell

A negative electrode current collector tab made of nickel foil was spot welded to the just-described negative electrode (30.5 mm×580.0 mm). In addition, 15 sheets of the above-described positive electrode (30.0 mm×30.0 mm) were prepared, and in preparing the positive electrodes, positive electrode current collector tabs were produced from the portions of the aluminum foil positive electrode current collectors on which the positive electrode slurry was not applied. Specifically, a portion of the positive electrode current collector on which the positive electrode slurry was not applied was left unremoved, and the unremoved portion of the positive electrode current collector, on which the positive electrode slurry was not applied, was utilized as a positive electrode current collector tab. As will be described layer, the positive electrode current collector tabs were formed so as to be disposed staggered at five locations in the structure in which the negative electrode and the positive electrode were stacked. Accordingly, in the electrode assembly in which the electrodes are stacked, three positive electrode current collector tabs are overlapped at each of the five locations.

A 16 μm-thick microporous polyethylene film was used as separators.

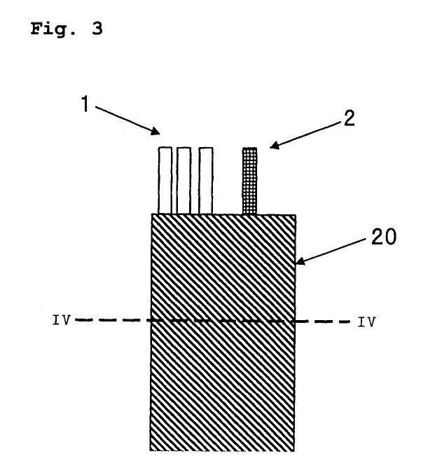

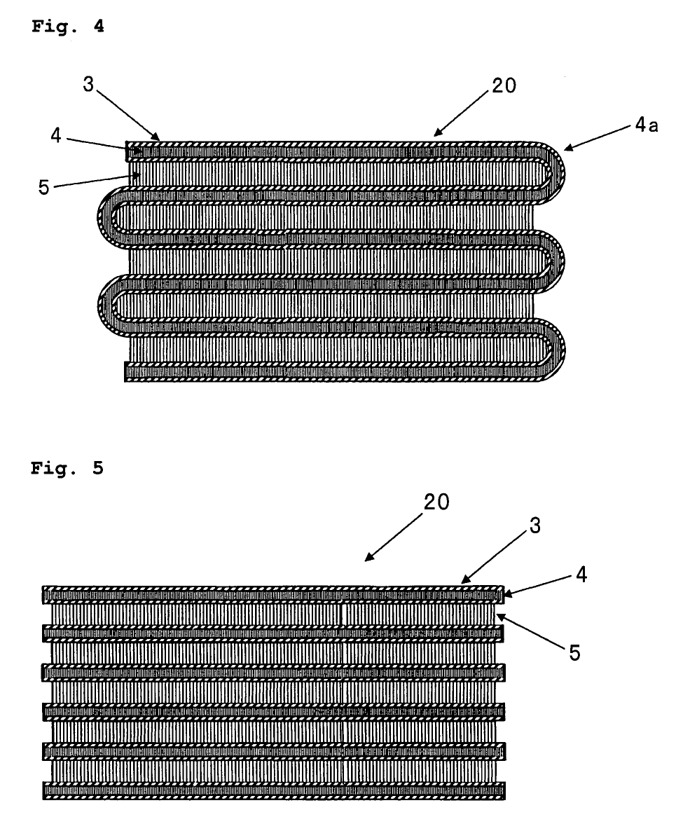

Using the above-described positive electrode, negative electrode, and separators, an electrode assembly as illustrated in FIGS. 3 and 4 was prepared. FIG. 3 is a plan view illustrating the electrode assembly 20, and FIG. 4 is a cross-sectional view taken along line IV-IV in FIG. 3. As illustrated in FIG. 4, negative electrode 4 is folded and overlapped alternately, and each of positive electrodes 5 is disposed between the overlapping surfaces of the negative electrode 5. Separators 3 are provided on both sides of the negative electrode, and the negative electrode 4 and each of the sheets of the positive electrode are provided opposing each other across one of the separators 3. The electrode assembly is configured so that the positive electrode 5 is not present on the outer side of each bent portion of the negative electrode.

A negative electrode current collector tab 2 is connected to the negative electrode 4. Since the negative electrode 4 comprises one sheet, the number of the negative electrode current collector tab 2 attached thereto is one. The number of the positive electrode sheets 5 is 15. Since each of the positive electrode sheets is provided with a respective one of the positive electrode current collector tabs 1 attached thereto, the electrode assembly is accordingly provided with 15 positive electrode current collector tabs 1. Although FIG. 3 depicts only three locations where the positive electrode current collector tabs 1 are provided, the positive electrode current collector tabs are disposed staggered at five locations, and three positive electrode current collector tabs 1 are overlapped at each of the locations.

The electrode assembly obtained in the above-described manner was inserted into a battery can, to fabricate a prismatic lithium secondary battery.

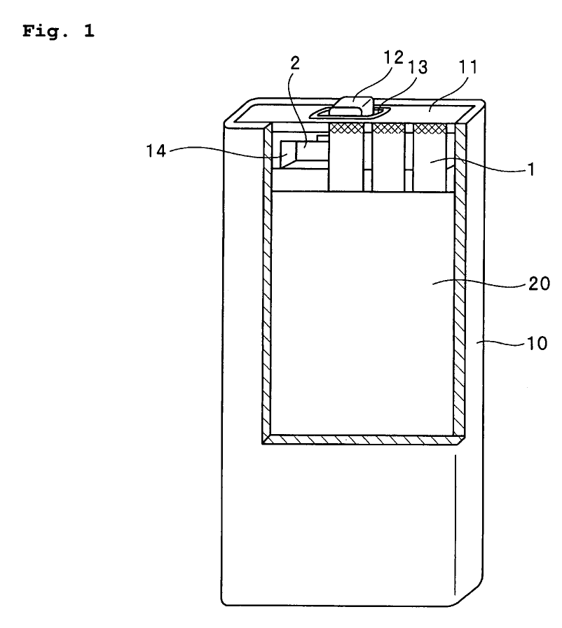

FIG. 1 is a partially cut-away perspective view illustrating the resulting lithium secondary battery. As illustrated in FIG. 1, the electrode assembly 20 is accommodated in a battery can 10 made of aluminum, and the upper opening of the battery can 10 is sealed by fitting a sealing plate 11 therein. A battery case is constituted by the battery can 10 and the sealing plate 11. A laser beam is applied to a joint portion of the battery can 10 and the sealing plate 11 and an adjacent portion thereof, whereby the battery can 10 and the sealing plate 11 are welded together. In this welding, the positive electrode current collector tabs 1 are also welded by the laser beam, whereby the positive electrode current collector tabs 1 are electrically connected to the battery can 10 and the sealing plate 11. Although FIG. 1 depicts only three locations where the positive electrode current collector tabs 1 are provided, the positive electrode current collector tabs 1 are disposed staggered at five locations as described above, and three positive electrode current collector tabs are overlapped at each of the locations. The three positive electrode current collector tabs 1 overlapped at each location are welded at the same time as the sealing plate 11 and the battery can 10 are laser welded together as described above, and the three positive electrode current collector tabs 1 are electrically connected to a side part of the sealing plate 11, which is a positive electrode terminal portion.

The sealing plate 11A has a hole formed at the center thereof, in which a battery cap 12 is provided via an insulative gasket 13. The negative electrode current collector tab 2 of the electrode assembly 20 is electrically connected to the battery cap 12. The negative electrode current collector tab 2 is insulated from the sealing plate 11 and the battery can 10 by an insulating plate 14.

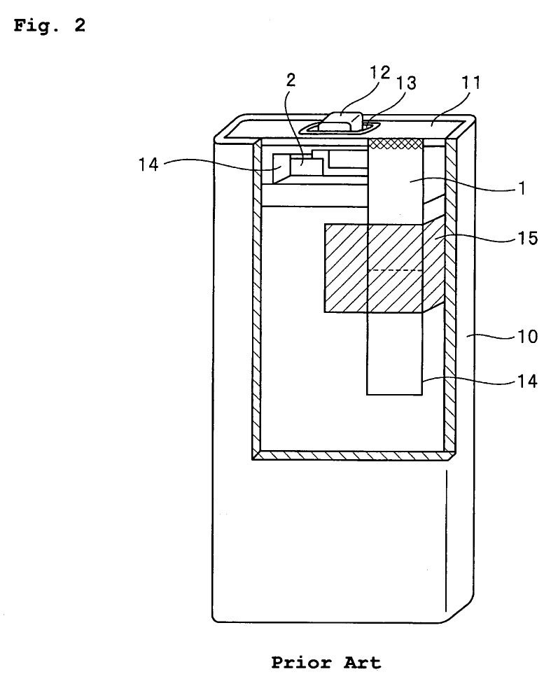

FIG. 2 is a partially cut-away perspective view illustrating a comparative example lithium secondary battery. In this comparative example, a sheet of negative electrode (30.5 mm×580.0 mm) to which a negative electrode current collector tab made of nickel foil was spot welded, and a sheet of positive electrode (29.5 mm×570.0 mm) were spirally coiled with a 16 μm-thick polyethylene separator interposed therebetween, to form an electrode assembly. The positive electrode active material was applied onto only one side of the positive electrode current collector, which was faced inward of the electrode assembly, to form the electrode assembly. Thus, in the electrode assembly of this comparative example, one sheet of the negative electrode and one sheet of the positive electrode were used to form the electrode assembly.

As illustrated in FIG. 2, the positive electrode current collector is exposed at the outermost portion of the electrode assembly. In the exposed portion of the positive electrode current collector, a substantially angular U shaped cut was formed, and a tab formed by the cut was folded over upward, whereby a positive electrode current collector tab 1 was formed. A protective tape 15 was adhered to a portion of the positive electrode current collector tab 1 that was folded over after providing the cut 14. Specifically, the battery of the present comparative example was fabricated according to the technique disclosed in Japanese Published Unexamined Patent Application No. 9-171809.

A battery can 10 and a sealing plate 11 were welded by laser welding in the same manner as used for the battery of the example shown in FIG. 1. At the same time, the positive electrode current collector tab 1 was electrically connected to the sealing plate 11 and the battery can 10 by welding the positive electrode current collector tab 1 between the sealing plate 11 and the battery can 10. A negative electrode current collector tab 2 made of nickel was spot-welded to the negative electrode, and the negative electrode current collector tab of electrode assembly 20 was electrically connected to battery cap 2, whereby a lithium secondary battery was fabricated.

Evaluation of Charge-Discharge Cycle Performance

A charge-discharge cycle test was conducted for the example battery shown in FIG. 1 and the comparative example battery shown in FIG. 2. Each of the batteries was charged at 25° C. at a current of 1000 mA to 4.2 V and was thereafter discharged at a current of 1000 mA to 2.75 V. This process was defined as one charge-discharge cycle. The charge-discharge cycle was repeated to determine the number of cycles until the discharge capacity of each battery reached 80% of the discharge capacity at the first cycle, and the number of cycles thus obtained was taken as the cycle life of the battery. The results of the measurement are shown in Table 1 below. It should be noted that the cycle life value for the comparative example battery is an index number relative to the cycle life of the example battery, which is taken as 100.

TABLE 1

| | Electrode assembly | |
|---|---|---|
| | structure | Cycle life |
| Comparative | Wound structure | 25 |
| Battery | | |
| Example Battery | Folded structure | 100 |

As apparent from the results shown in Table 1, the example battery, which has the electrode assembly structure according to the present invention, exhibits better cycle performance than that of the comparative example battery. The reason is believed to be as follows. Since the positive electrode is not present on the outer side of the bent portion of the negative electrode in the example battery, no charge-discharge reaction occurs in that portion. Thus, the stress that is caused by a volumetric change of the negative electrode can be appropriately alleviated in the bent portion, and thereby, wrinkles or bends can be prevented from occurring.

FIG. 5 is a cross-sectional view illustrating the structure of the electrode assembly in another example according to the present invention. In the present invention, it is possible to adopt an electrode assembly as illustrated in FIG. 5. The electrode assembly shown in FIG. 5 employs a stacked structure in which a plurality of positive electrode sheets 5 are disposed between a plurality of negative electrode sheets 4, and separators 3 are disposed between the negative electrode sheets 4 and the positive electrode sheets 5. This case also requires a plurality of positive electrode current collector tabs, and therefore, the volumetric energy density of the battery can be increased without increasing the enclosing space in the battery case by disposing, according to the present invention, a plurality of positive electrode current collector tabs staggered at a plurality of locations. The electrode assembly shown in FIG. 5 also requires a plurality of negative electrode current collector tabs. Therefore, it is preferable that the negative electrode current collector tabs be likewise disposed staggered at a plurality of locations.

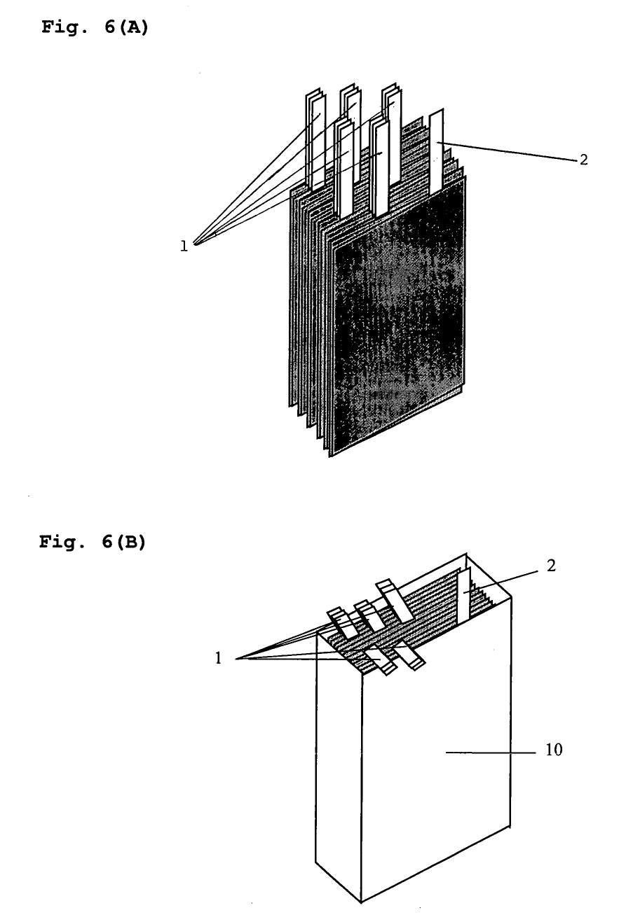

FIG. 6(A) shows an electrode assembly of the present invention as described above in which 15 positive electrode current collector tabs 1 are staggered at five locations with three positive electrode current collector tabs being overlapped at each location, and in which a negative electrode current collector tab 2 is attached to the negative electrode.

FIG. 6(B) is a perspective view of the electrode assembly of FIG. 6(A) inserted into a battery can 10.

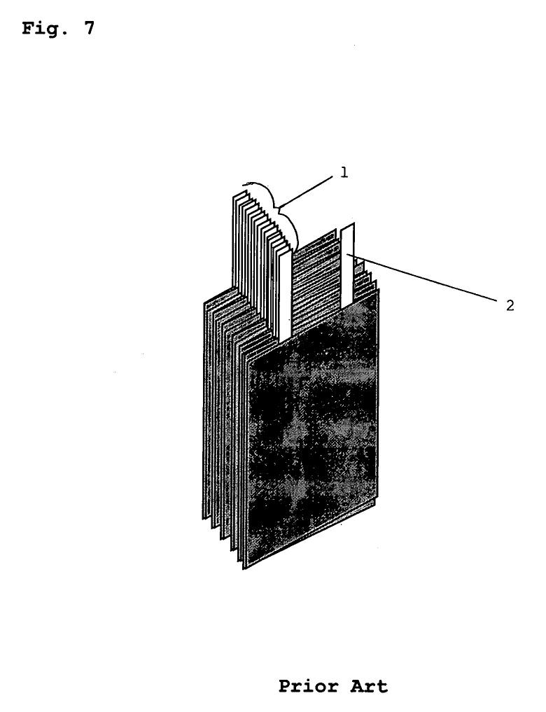

FIG. 7 shows an electrode assembly of the prior art as disclosed in Japanese Published Unexamined Patent Application No. 2005-174653 in which all of the positive electrode current collector tabs 1 are overlapped at one location.

Only selected embodiments have been chosen to illustrate the present invention. To those skilled in the art, however, it will be apparent from the foregoing disclosure that various changes and modifications can be made herein without departing from the scope of the invention as defined in the appended claims. Furthermore, the foregoing description of the embodiments according to the present invention is provided for illustration only, and is not intended to limit the invention as defined by the appended claims and their equivalents.

This application claims priority of Japanese patent application No. 2006-098759 filed Mar. 31, 2006, which is incorporated herein by reference.

What is claimed is:

1. A lithium secondary battery comprising:
a plurality of sheets of a positive electrode;
at least one sheet of a negative electrode;
a separator disposed between each positive electrode sheet and the at least one sheet of negative electrode;
an electrode assembly comprising the plurality of sheets of the positive electrode, the at least one sheet of the negative electrode, and the separator, in which the plurality of sheets of positive electrode and the at least one sheet of the negative electrode are stacked with the separators interposed therebetween;
a battery case for accommodating the electrode assembly; and
positive electrode current collector tabs, attached to individual sheets of the positive electrode, for connecting the sheets of the positive electrode to a positive electrode terminal portion of the battery case, the positive electrode current collector tabs being disposed staggered at a plurality of locations in the electrode assembly in which the electrodes are stacked.

2. The lithium secondary battery according to claim 1, wherein, in the electrode assembly in which the electrodes are stacked, positive electrode current collector tabs are overlapped and the number that are overlapped at a same location is three or less.

3. The lithium secondary battery according to claim 1, wherein, in the electrode assembly in which the electrodes are stacked, the at least one sheet of the negative electrode is folded and overlapped alternately and the sheets of the positive electrode are disposed between overlapping surfaces of the negative electrode, whereby the positive electrode and the negative electrode are stacked.

4. The lithium secondary battery according to claim 2, wherein, in the electrode assembly in which the electrodes are stacked, the at least one sheet of the negative electrode is folded and overlapped alternately and the sheets of the positive electrode are disposed between overlapping surfaces of the negative electrode, whereby the positive electrode and the negative electrode are stacked.

5. The lithium secondary battery according to claim 1, wherein, in the electrode assembly in which the electrodes are stacked, the positive electrode is not disposed on an outer side of a folded portion of the negative electrode.

6. The lithium secondary battery according to claim 2, wherein, in the electrode assembly in which the electrodes are stacked, the positive electrode is not present on an outer side of a folded portion of the negative electrode.

7. The lithium secondary battery according to claim 3, wherein, in the electrode assembly in which the electrodes are stacked, the positive electrode is not present on an outer side of a folded portion of the negative electrode.

8. The lithium secondary battery according to claim 4, wherein, in the electrode assembly in which the electrodes are stacked, the positive electrode is not present on an outer side of a folded portion of the negative electrode.

9. The lithium secondary battery according to claim 1, wherein the negative electrode contains silicon as an active material.

10. The lithium secondary battery according to claim 2, wherein the negative electrode contains silicon as an active material.

11. The lithium secondary battery according to claim 7, wherein the negative electrode contains silicon as an active material.

12. The lithium secondary battery according to claim 8, wherein the negative electrode contains silicon as an active material.

13. The lithium secondary battery according to claim 9, wherein the negative electrode comprises a negative electrode current collector and a negative electrode mixture layer sintered on the negative electrode current collector, the negative electrode mixture layer containing a negative electrode binder and an active material containing silicon.

14. The lithium secondary battery according to claim 12, wherein the negative electrode comprises a negative electrode current collector and a negative electrode mixture layer sintered on the negative electrode current collector, the negative electrode mixture layer containing a negative electrode binder and an active material containing silicon.

15. The lithium secondary battery according to claim 13, wherein the negative electrode binder comprises a polyimide.

16. The lithium secondary battery according to claim 14, wherein the negative electrode binder comprises a polyimide.

17. The lithium secondary battery according to claim 1, wherein the battery case is formed of aluminum, an aluminum alloy or an aluminum laminate film.

18. The lithium secondary battery according to claim 4, wherein the battery case is formed of aluminum, an aluminum alloy or an aluminum laminate film.

19. The lithium secondary battery according to claim 12, wherein the battery case is formed of aluminum, an aluminum alloy or an aluminum laminate film.

20. The lithium secondary battery according to claim 16, wherein the battery case is formed of aluminum, an aluminum alloy or an aluminum laminate film.
